(19) United States
(12) Patent Application Publication
(10) Pub. No.: US 2024/0427075 A1
(43) Pub. Date: Dec. 26, 2024

(54) WAVEGUIDES INCLUDING A BLUE WAVEGUIDE FILM

(71) Applicant: GOOGLE LLC, Mountain View, CA (US)

(72) Inventors: Eliezer Glik, San Diego, CA (US); Pierre St. Hilaire, Belmont, CA (US)

(21) Appl. No.: 18/746,970

(22) Filed: Jun. 18, 2024

Related U.S. Application Data
(60) Provisional application No. 63/522,659, filed on Jun. 22, 2023.

(51) Int. Cl. F21V 8/00; G02B 27/00; G02B 27/01

(52) U.S. Cl. CPC G02B 6/0076; G02B 6/0016; G02B 6/0036; G02B 6/0065; G02B 27/0081; G02B 27/0172; G02B 2027/0174; G02B 2027/0178

(57) ABSTRACT

A stacked waveguide is configured to provide light representative of an image to the eye of a user. To this end, the stacked waveguide includes a first waveguide having a first refraction index and including an incoupler configured to direct a first portion of display light having a first wavelength and a second portion of display light that has a second, different wavelength into the first waveguide. Further, the stacked waveguide includes a second waveguide having a second, different refraction index and including an incoupler configured to direct a third portion of display light having a third wavelength different from the first and second wavelengths into the second waveguide.

### BACKGROUND

Waveguides, such as those used in head-worn displays (HWDs), are commonly configured to provide light representative of an image emitted from a projector to an eye of a user. To this end, some waveguides include an incoupler and an outcoupler each having gratings configured to direct light. The incoupler of a waveguide is configured to first receive light emitted from a projector and direct the light into the waveguide such that the light propagates through the waveguide toward the outcoupler. After receiving the light, the outcoupler directs the light of the waveguide toward the eye of the user. However, to increase the range of colors of light that are provided to the eye of the user, additional components are added to the HWDs such as additional waveguides. These additional waveguides increase the weight, size, and cost of the HWDs and negatively impact user experience.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a diagram of an example display system housing a projector system configured to project images toward the eye of a user, in accordance with some embodiments.

FIG. 2 is a diagram illustrating a projection system that projects images directly onto the eye of a user via display light, in accordance with some embodiments.

FIG. 3 is a diagram illustrating an example waveguide exit pupil expansion system, in accordance with embodiments.

FIG. 4 is a diagram illustrating an example projection system having an optical relay including a molded reflective relay, in accordance with some embodiments.

FIG. 5 is a diagram illustrating example paths that concurrent portions of display lights take through an optical relay, in accordance with some embodiments.

FIG. 6 is a diagram illustrating an example configuration for a stacked waveguide having a first waveguide and a second waveguide, in accordance with some embodiments.

FIG. 7 is a diagram illustrating an example configuration of a stacked waveguide configured to receive display light from two or more optical engines, in accordance with some embodiments.

FIG. 8 is a diagram illustrating an example configuration for an optical combiner having a stacked waveguide, in accordance with embodiments.

FIG. 9 is a diagram illustrating another example configuration for an optical combiner having a stacked waveguide, in accordance with embodiments.

FIG. 10 is a diagram illustrating a partially transparent view of a head-worn display (HWD) that includes a laser projection system, in accordance with some embodiments.

### DETAILED DESCRIPTION

Some head-worn displays (HWDs) (e.g., augmented reality HWDs, virtual reality HWDS) are designed to look like eyeglasses, with at least one of the lenses containing a waveguide to direct display light to a user's eye. This display light directed to a user's eye includes wavelengths associated with different colors of light such as green light, red light, and blue light. The combination of the lens and waveguide is referred to as an “optical combiner,” “optical combiner lens,” or both. Such waveguides form, for example, exit pupil expanders (EPEs) and outcouplers that form and guide light to the user's eye. The HWDs generally have a frame designed to be worn in front of a user's eyes to allow the user to view both their environment and computer-generated content projected from the combiner. Components that are necessary to the functioning of a typical HWD, such as, for example, an optical engine to project computer-generated content (e.g., display light representative of one or more images), cameras to pinpoint physical location, cameras to track the movement of the user's eye(s), processors to power the optical engine, and a power supply, are typically housed within the frame of the HWD. As an HWD frame has limited volume in which to accommodate these components, it is desirable that these components be as small as possible and configured to interact with the other components in very small volumes of space.

However, the human eye is more sensitive to light having wavelengths associated with green and red light than wavelengths associated with blue light. As such, to help reduce the size and weight of a waveguide in an HWD, systems and techniques disclosed herein are directed to a stacked waveguide having a first waveguide configured to receive wavelengths of a display light associated with red and green light and a second waveguide configured to receive wavelengths of the display light associated with blue light. As an example, a stacked waveguide includes a first waveguide configured to direct wavelengths of a display light associated with red and green light toward the eye of a user and a second waveguide configured to direct wavelengths of the display light associated with blue light toward the eye of a user. To this end, the first waveguide includes an incoupler configured to receive at least a portion of the display light and direct a first portion of the display light having a wavelength associated with red light and a second portion of the display light having a wavelength associated with green light into the first waveguide. Further, the first waveguide includes an outcoupler configured to provide the first and second portions of the display light to the eye of a user. The second waveguide of the stacked waveguide includes an incoupler configured to receive at least a portion of the display light and direct a third portion of the display light having a third wavelength associated with blue light into the second waveguide. The second waveguide also includes an outcoupler configured to provide the third portion of the display light to the eye of the user.

Because human eye acuity is less sensitive to wavelengths associated with blue light than wavelengths associated with red light and green light, the specifications of the second waveguide are able to be reduced without negatively impacting user experience. That is to say, the second waveguide is able to have lower specifications than the first waveguide without the quality of the projected image being perceptibly reduced for the user. Because the second waveguide is carrying only one color, the refractive index can be less than the first waveguide. As such, within the stacked waveguide, the first waveguide includes a first material having a first refraction index and the second waveguide includes a second material having a second refraction index that is less than the first refraction index. Further, the second material of the second waveguide includes a thickness, weight, cost, or any combination thereof that is lower than the material of the first waveguide. In this way, a thinner, lighter, or less costly material for the second waveguide, such as plastic, is used, reducing the size, weight, or cost of the HMD respectively without lowering the perceptible quality of the projected image and negatively impacting user experience.

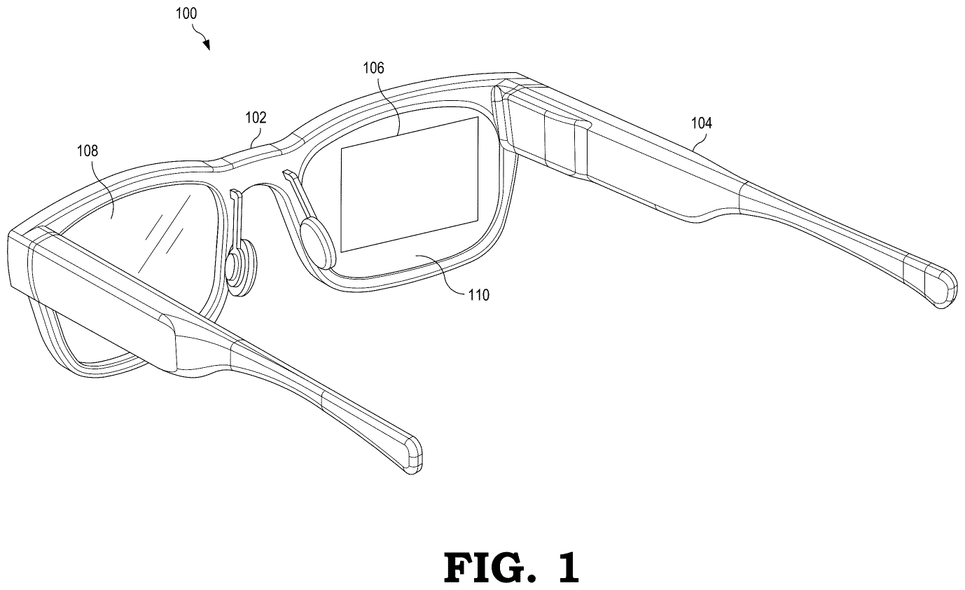

FIG. 1 illustrates an example display system 100 having a support structure 102 that includes an arm 104, which houses a projection system configured to project display light representative of images toward the eye of a user, such that the user perceives the projected images as being displayed in a field of view (FOV) area 106 of a display at one or both of lens elements 108, 110. In the depicted embodiment, the display system 100 is a head-worn display (HWD) that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a projector, an optical scanner, and a waveguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, display light used to form a perceptible image or series of images may be projected by a projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler of the waveguide to an outcoupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide an FOV of the user's real-world environment such that the image appears superimposed over at least a portion of the real-world environment.

In some embodiments, the projector is a digital light processing-based projector, a microdisplay, scanning laser projector, or any combination of a modulative light source. For example, according to some embodiments, the projector includes a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be MEMS-based or piezo-based). The projector is communicatively coupled to the controller and a non-transitory processor-readable storage medium or a memory that stores processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106 and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, the projector routes light via first and second scan mirrors, a multi-pass optical relay disposed between the first and second scan mirrors, and a waveguide disposed at the output of the second scan mirror. In some embodiments, at least a portion of an outcoupler of the waveguide may overlap the FOV area 106. These aspects are described in greater detail below.

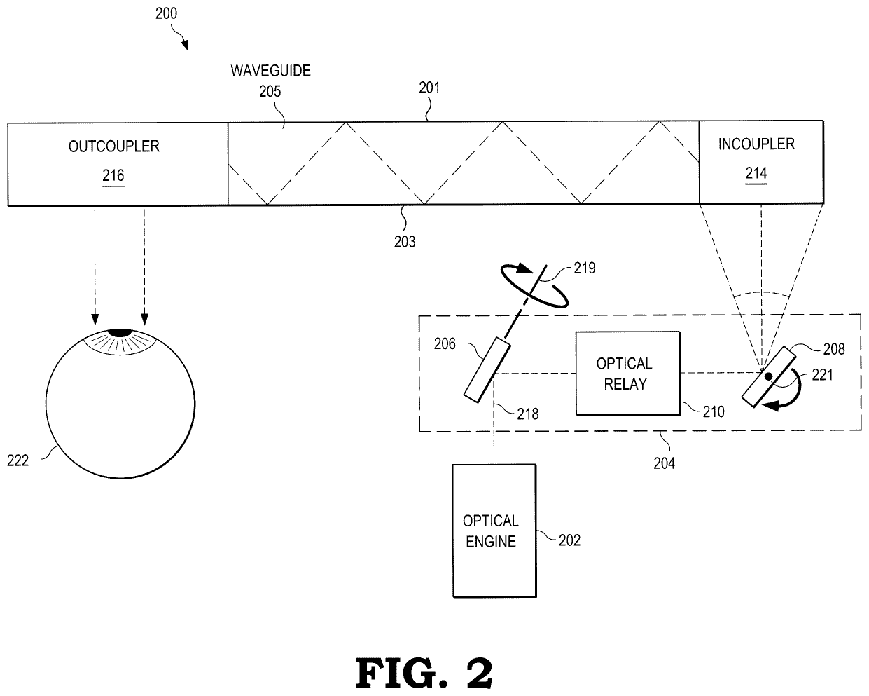

FIG. 2 illustrates a simplified block diagram of a projection system 200 that projects images directly onto the eye of a user via display light. The projection system 200 includes an optical engine 202, an optical scanner 204, and a waveguide 205. The optical scanner 204 includes a first scan mirror 206, a second scan mirror 208, and an optical relay 210. The waveguide 205 has a first major surface 201 and a second, opposing major surface 203. Further, the waveguide 205 includes an incoupler 214 and an outcoupler 216, with the outcoupler 216 being optically aligned with an eye 222 of a user in the present example. In some embodiments, the projection system 200 is implemented in a WHD or other display system, such as the display system 100 of FIG. 1.

The optical engine 202 includes one or more light sources configured to generate and output display light 218 (e.g., visible light such as red, blue, and green light and/or non-visible light such as infrared light). These light sources, for example, include one or more lasers, light emitting diodes (LEDs), organic LEDs (OLEDs), or any combination thereof. In some embodiments, the optical engine 202 is coupled to a driver or other controller (not shown), which controls the timing of emission of light from the light sources of the optical engine 202 in accordance with instructions received by the controller or driver from a computer processor coupled thereto to modulate the display light 218 to be perceived as images when output to the retina of an eye 222 of a user.

For example, during the operation of the projection system 200, multiple display light beams having respectively different wavelengths are output by the light sources of the optical engine 202, then combined via a beam combiner (not shown), before being directed to the eye 222 of the user. As an example, the projection system 200 emits a first display light beam having a first wavelength associated with green light, a second display light beam having a second wavelength associated with red light, and a third display light beam having a third wavelength associated with blue light. The optical engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time.

One or both of the scan mirrors 206 and 208 of the optical scanner 204 are MEMS mirrors in some embodiments. For example, in some embodiments, the scan mirror 206 and the scan mirror 208 are MEMS mirrors that are driven by respective actuation voltages to oscillate during active operation of the projection system 200, causing the scan mirrors 206 and 208 to scan the display light 218. Oscillation of the scan mirror 206 causes display light 218 output by the optical engine 202 to be scanned through the optical relay 210 and across a surface of the second scan mirror 208. The second scan mirror 208 scans the display light 218 received from the scan mirror 206 toward an incoupler 214 of the waveguide 205. In some embodiments, the scan mirror 206 oscillates along a first scanning axis 219, such that the display light 218 is scanned in only one dimension (e.g., in a line) across the surface of the second scan mirror 208. In some embodiments, the scan mirror 208 oscillates or otherwise rotates along a second scanning axis 221. In some embodiments, the first scanning axis 219 is perpendicular to the second scanning axis 221.

In some embodiments, the incoupler 214 has a substantially rectangular, circular, or elliptical profile and is configured to receive the display light 218 and direct the display light 218 into the waveguide 205. The incoupler 214 is defined by a smaller dimension (i.e., width) and a larger orthogonal dimension (i.e., length). In an embodiment, the optical relay 210 is a line-scan optical relay that receives the display light 218 scanned in a first dimension by the first scan mirror 206 (e.g., the first dimension corresponding to the small dimension of the incoupler 214), routes the display light 218 to the second scan mirror 208, and introduces a convergence to the display light 218 in the first dimension to an exit pupil beyond the second scan mirror 208. Herein, an “exit pupil” in an optical system refers to the location along the optical path where beams of light intersect. For example, the possible optical paths of the display light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the display light 218 corresponding to that exit pupil. Accordingly, the exit pupil can be considered a “virtual aperture”. According to various embodiments, the optical relay 210 includes one or more collimation lenses that shape and focus the display light 218 on the second scan mirror 208 or includes a molded reflective relay that includes two or more spherical, aspheric, parabolic, and/or freeform lenses that shape and direct the display light 218 onto the second scan mirror 208. The second scan mirror 208 receives the display light 218 and scans the display light 218 in a second dimension, the second dimension corresponding to the long dimension of the incoupler 214 of the waveguide 205. In some embodiments, the second scan mirror 208 causes the exit pupil of the display light 218 to be swept along a line along the second dimension. In some embodiments, the incoupler 214 is positioned at or near the swept line downstream from the second scan mirror 208 such that the second scan mirror 208 scans the display light 218 as a line or row over the incoupler 214.

In some embodiments, the optical engine 202 includes an edge-emitting laser (EEL) that emits a display light 218 having a substantially elliptical, non-circular cross-section, and the optical relay 210 magnifies or minimizes the display light 218 along its semi-major or semi-minor axis to circularize the display light 218 prior to the convergence of the display light 218 on the second scan mirror 208. In some such embodiments, a surface of a mirror plate of the scan mirror 206 is elliptical and non-circular (e.g., similar in shape and size to the cross-sectional area of the display light 218). In other such embodiments, the surface of the mirror plate of the scan mirror 206 is circular.

The waveguide 205 of the laser projection system 200 includes the incoupler 214 and the outcoupler 216. The term “waveguide,” as used herein, will be understood to mean a combiner using one or more of total internal reflection (TIR), partial internal reflection (PIR), specialized filters, and/or reflective surfaces, to transfer light from an incoupler (such as the incoupler 214) to an outcoupler (such as the outcoupler 216). In some display applications, the light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the display light 218 received at the incoupler 214 is relayed to the outcoupler 216 via the waveguide 205 using TIR. The display light 218 is then output to the eye 222 of a user via the outcoupler 216. As described above, in some embodiments the waveguide 205 is implemented as part of an eyeglass lens, such as the lens element 108 or lens element 110 (e.g., FIG. 1) of the display system having an eyeglass form factor and employing the projection system 200.

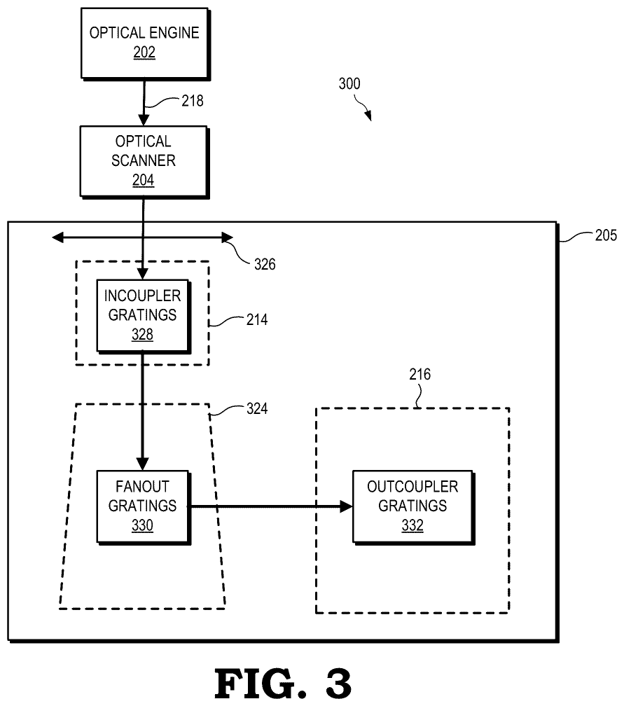

Although not shown in the example of FIG. 2, in some embodiments additional optical components are included in any of the optical paths between the optical engine 202 and the scan mirror 206, between the scan mirror 206 and the optical relay 210, between the optical relay 210 and the scan mirror 208, between the scan mirror 208 and the incoupler 214, between the incoupler 214 and the outcoupler 216, and/or between the outcoupler 216 and the eye 222 (e.g., in order to shape the display light for viewing by the eye 222 of the user). In some embodiments, a prism is used to steer display light from the scan mirror 208 into the incoupler 214 so that display light is coupled into incoupler 214 at the appropriate angle to encourage the propagation of the display light in waveguide 205 by TIR. Also, in some embodiments, an exit pupil expander (EPE) (e.g., EPE 324 of FIG. 3, described below), such as a fold grating, is arranged in an intermediate stage between incoupler 214 and outcoupler 216 to receive display light that is coupled into waveguide 205 by the incoupler 214, expand the display light, and redirect the display light towards the outcoupler 216, where the outcoupler 216 then couples the display light out of waveguide 205 (e.g., toward the eye 222 of the user).

FIG. 3 illustrates a waveguide exit pupil expansion system 300, according to embodiments. In embodiments, waveguide exit pupil expansion system 300 is implemented in, for example, display system 100 and is configured to provide an image to an eye 222 of a user of an HWD. To this end, waveguide pupil expansion system 300 includes optical engine 202, optical scanner 204, and waveguide 205. According to embodiments, optical engine 202 is configured to prseocoject display light 218 (e.g., light having one or more wavelengths associated with white light, green light, red light, blue light, infrared light, ultraviolet light, or any combination thereof) towards optical scanner 204. In response to receiving display light 218, optical scanner 204 is configured to scan display light 218 along at least a first scanning axis 326, for example, by using one or more scan mirror 206, 208 each configured to oscillate about a respective axis 219, 221. Optical scanner 204 is then configured to provide display light 218 as scanned along at least a first scanning axis 326 to incoupler 214 of waveguide 205.

After receiving display light 218, incoupler 214 is configured to guide display light 218 from incoupler 214 to EPE 324 via at least a portion of waveguide 205. For example, incoupler 214 guides display light 218 from incoupler 214 such that display light 218 propagates through at least a portion of waveguide 205 via TIR, PIR, or both and is received at EPE 324. To this end, incoupler 214 includes one or more incoupler gratings 328 each configured to diffract or reflect display light 218 in one or more directions into a portion of waveguide 205. Such incoupler gratings 328, for example, include one or more grating structures (e.g., Bragg grating structures, surface-relief grating structures, polarization volume grating structures, volumetric holographic grating structures) disposed on a surface of waveguide 205 and configured to diffract received display light based on the angle of the grating structures, the material of the grating structures, or both into at least a portion of waveguide 205. As another example, incoupler gratings 328 include one or more reflective structures (e.g., mirrors, facets, coatings) disposed within waveguide 205 and configured to reflect display light based on the angle of the reflective structures, the material of the reflective structures, or both into at least a portion of waveguide 205. In response to receiving display light 218 from incoupler 214 (e.g., via at least a portion of waveguide 205), EPE 324 is configured to expand the eyebox of the display represented by display light 218. For example, EPE 324 is configured to diffract display light 218 such that the exit pupil of display light 218 is enlarged (e.g., expanded).

To expand the exit pupil of display light 218, EPE 324 includes, for example, one or more fanout gratings 330 that are configured to diffract received display light so as to increase the size of the exit pupil of the display light (e.g., expand the exit pupil of the light). Such fanout gratings 330, for example, include one or more grating structures (e.g., Bragg grating structures, surface-relief grating structures, polarization volume grating structures, volumetric holographic grating structures) configured to diffract light received according to the angle of the grating structures, the material of the grating structures, or both such that the exit pupil of the display light is expanded. According to embodiments, EPE 324 provides display light 218 with the expanded exit pupil to at least a second portion of waveguide 205 configured to propagate display light 218 (e.g., via TIR, PIR) toward outcoupler 216. For example, fanout gratings 330 are configured to diffract received display light 218 such that the exit pupil of display light 218 is expanded and display light 218 is provided to outcoupler 216 via at least a second portion of waveguide 205. Outcoupler 216 is then configured to direct received display light 218 out of waveguide 205 and towards the eye 222 of a user. To this end, outcoupler 216 includes one or more outcoupler gratings 332 configured to diffract or reflect received display light 218 out of waveguide 205. Outcoupler gratings 332 includes, for example, one or more grating structures (e.g., Bragg grating structures, surface-relief grating structures, polarization volume grating structures, volumetric holographic grating structures) configured to diffract display light based on the angle of the grating structures, the material of the grating structures, or both such that the light is directed out of waveguide 205 and toward the eye 222 of a user. As another example, outcoupler gratings 332 include one or more reflective structures (e.g., facets, mirrors, coatings) configured to reflect display light based on the angle of the reflective structures, the material of the reflective structures, or both such that the display light is directed out of waveguide 205 and toward the eye 222 of a user

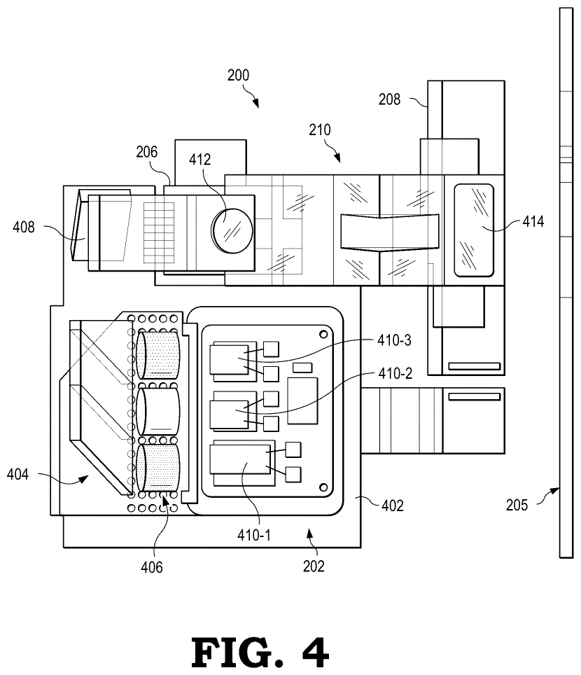

FIG. 4 shows an example embodiment of the projection system 200 in which the optical relay 210 includes a molded reflective relay. As shown, the laser projection system 200 includes a substrate 402 on which a beam combiner 404, primary lenses 406, and a mirror 408 are disposed. According to various embodiments, the substrate 402 is a printed circuit board (PCB) or otherwise another applicable substrate.

The optical engine 202 comprises a set of one or more light sources 410 (e.g., laser diodes, LEDs, OLEDs), such as the illustrated red light source 410-1, green light source 410-2, and blue light source 410-3. In embodiments, a processor or other controller operates the optical engine 202 to modulate the respective intensity of each light source 410 so as to provide corresponding beams of display light having a wavelength associated with red light (e.g., between 620 to 750 nanometers), having a wavelength associated with green light (e.g., between 500 to 570 nanometers), and having a wavelength associated with blue light (e.g., between 450 and 495 nanometers) that contribute to a corresponding pixel of an image being generated for display to the user. The primary lenses 406 includes a corresponding number of collimation lenses (e.g., three for the three light sources 410 in the example above), each interposed in the light path between a respective light source 410 of the optical engine 202 and the beam combiner 404. For example, each light source 410 outputs a different wavelength of display light (e.g., corresponding to respective red, blue, and green wavelengths) through the primary lenses 406 to be combined at the beam combiner 404 to produce the display light (i.e., display light 218 shown in FIG. 2) to be projected by the projection system 200. The beam combiner 404 receives the individual display light inputs and outputs a combined display light 218 to the mirror 408, which redirects the display light 218 onto a reflective surface 412 of the scan mirror 206. The scan mirror 206 scans the display light 218 into the optical relay 210 across a first scanning axis.

In the example of FIG. 4, the optical relay 210 is a molded reflective relay, which may be, for example, molded from a solid clear component (e.g., glass or an optical plastic such as Zeonex) and the reflective surfaces thereof are implemented as mirror coatings or metasurfaces. Such molding can simplify the fabrication of the laser projection system 200 as it facilitates the incorporation of some or all of the optical surfaces of the relay into a single element, rather than several distinct, separate elements.

The optical relay 210 is configured to route the display light 218 toward a reflective surface 414 of the scan mirror 208. The scan mirror 208 scans the display light 218 across the incoupler (such as the incoupler 214) of the waveguide 205 along a second scanning axis that is perpendicular to the first scanning axis.

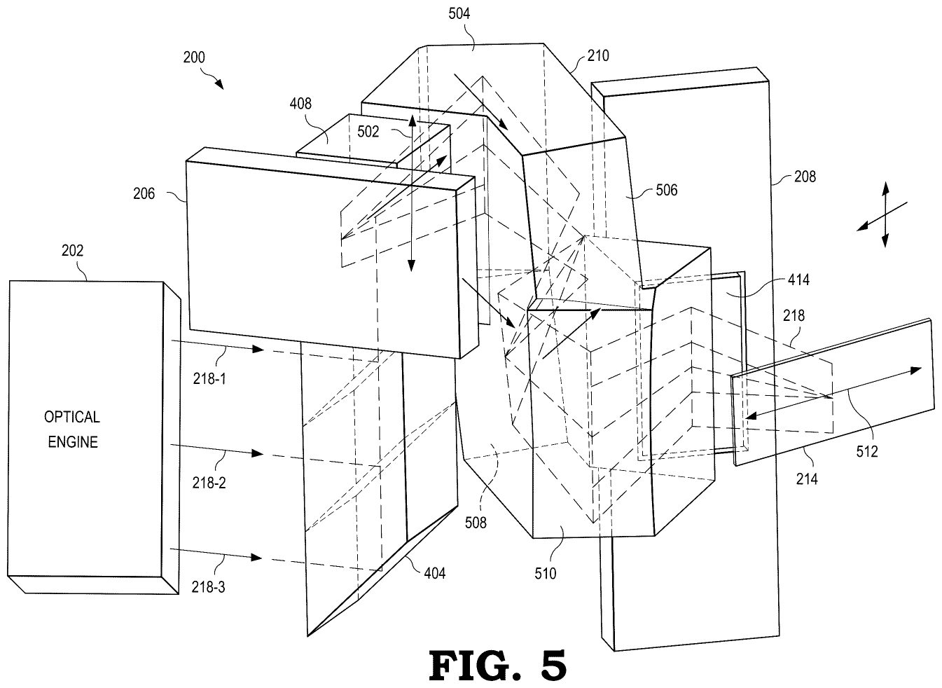

FIG. 5 shows an example of paths that the concurrent display lights output by the optical engine 202 can take through the optical relay 210 for an embodiment in which the optical relay 210 is a molded reflective relay. As shown, the optical engine 202 outputs red display light 218-1 (e.g., one or more beams of display light having a wavelength associated with red light), green display light 218-2 (e.g., one or more beams of display light having a wavelength associated with green light), and blue display light 218-3 (e.g., one or more beams of display light having a wavelength associated with blue light) toward the beam combiner 404. The beam combiner 404 combines individual beams of the display light 218-1, 218-2, 218-3 into the display light 218, and redirects the display light 218 toward the mirror 408, which reflects the display light 218 onto the scan mirror 206. The scan mirror 206 scans the display light 218 along a first scanning axis 502 into the optical relay 210. The optical relay 210 reflects the display light 218 off of reflective surfaces 504, 506, 508, and 510, then outputs the display light 218 toward the reflective surface 414 of the scan mirror 208. The scan mirror 208 then scans the display light 218 across the incoupler 214 along a second scanning axis 512, where the display light 218 converges onto the incoupler 214 at most or all achievable scan angles of the scan mirror 206.

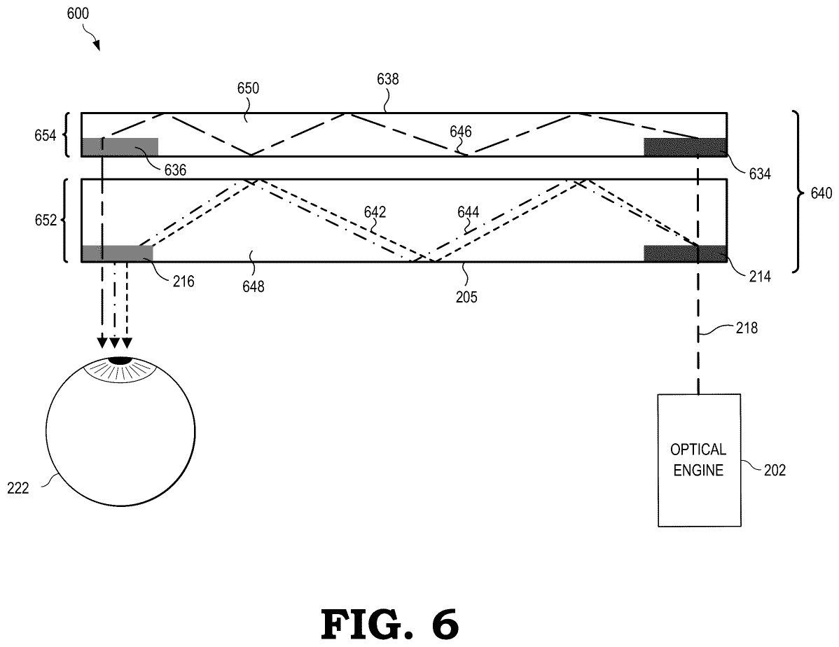

Referring now to FIG. 6, an example configuration 600 for a stacked waveguide including a first waveguide and a second waveguide is presented. According to embodiments, the example configuration 600 is implemented in display system 100 and is configured to provide an image to an eye 222 of a user. In embodiments, example configuration 600 includes a stacked waveguide 640 configured to provide one or more colors of display light 218 to an eye 222 of a user. To this end, the stacked waveguide 640 includes a first waveguide 205 configured to provide light having a wavelength associated with a first color (e.g., red) and light having a wavelength associated with a second color (e.g., green) to the eye 222 of a user. That is to say, the first waveguide 205, for example, is configured to provide a first portion of display light 218 having a first wavelength and a second portion of display light 218 having a second wavelength that is different from the first wavelength to the eye 222 of the user. As an example, the first waveguide 205 includes an incoupler 214 configured to receive display light 218 from optical engine 202. In response to receiving display light 218, the incoupler 214 is configured to direct a first portion 642 of display light 218 having a first wavelength (e.g., associated with red light) and a second portion 644 of display light 218 having a second wavelength (e.g., associated with green light) different from the first wavelength into a portion (e.g., main portion) of the first waveguide 205. Via TIR, the first waveguide then provides the first portion 642 of display light 218 and the second portion 644 of display light 218 to outcoupler 216. Outcoupler 216 then directs then provides the first portion 642 of display light 218 and the second portion 644 of display light 218 toward the eye 222 of the user. In embodiments, the first waveguide 205 is a linear waveguide that includes, for example, two linear, opposing major surfaces (e.g., major surfaces 201, 203).

Further, the stacked waveguide 640 includes a second waveguide 638, similar to or the same as waveguide 205, configured to provide light having a wavelength associated with a third color (e.g., blue) to the eye 222 of a user. In other words, for example, the second waveguide 638 is configured to provide a third portion 646 of display light 218 having a third wavelength that is different from the first and second wavelengths to the eye 222 of the user. For example, the second waveguide 638 includes an incoupler 634, similar to or the same as incoupler 214, configured to receive display light 218 from optical engine 202. In response to receiving display light 218, the incoupler 634 is configured to direct a third portion 646 of display light 218 having a third wavelength (e.g., associated with blue light) into a portion (e.g., main portion) of the second waveguide 638. Via TIR, the second waveguide 638 then provides the third portion 646 of display light 218 to outcoupler 636. Outcoupler 636, similar to or the same as outcoupler 216, then directs the third portion 646 of display light 218 toward the eye 222 of the user. In this way, stacked waveguide 640 is configured to provide display light 218 associated with multiple colors to the eye 222 of the user with the first waveguide providing two or more colors (e.g., green, red) of display light 218 to the eye 222 of the user and the second waveguide 638 providing a different color (e.g., blue) of display light 218 to the eye 222 of the user.

However, due to chromatic aberration, the eye 222 of the user is more sensitive to the portions (e.g., portions 642, 644) of display light 218 having wavelengths associated with green and red light than the portion (e.g., portion 646) of display light 218 having a wavelength associated with blue light. That is to say, in embodiments, the eye 222 of the user is more sensitive to the portions 642, 644 of display light 218 provided from the first waveguide 205 than the portion 646 of display light 218 provided from the second waveguide 638. As such, the second waveguide 638 is able to have a lower refraction index than the first waveguide 205 without any perceptible degradation of the image provided to the eye 222 of the user. As an example, in embodiments, the first waveguide 205 is formed from (e.g., includes) a first material 648 having a first refractive index (e.g., 1.5 or above). The first material 648 includes, for example, glass, plastic, or a combination of two. Additionally, based on at least the first material 648, the first waveguide 205 has an associated thickness 652 and weight so as to allow the first waveguide 205 to have the first refractive index and propagate at least a portion of display light 218. Further, according to some embodiments, the second waveguide 638 is formed (e.g., includes) a second material 650 that has a second refraction index different from the first refractive index. As an example, the second material 650 has a second refraction index lower than the first refraction index. The second material 650 includes, for example, glass, plastic, a film, a plastic film, a laminated film, or any combination thereof. According to some embodiments, as an example, using a plastic film for the second material 650 allows the second waveguide 638 to be fabricated using a roll-to-roll process, decreasing the cost of fabricating the second waveguide 638 and, thus, the stacked waveguide 640. Additionally, in embodiments, at least a portion of the second waveguide 638 is formed by bonding the second material 650 (e.g., a film, plastic film, laminated film) to a surface of a plastic substrate or glass substrate using a vacuum, an adhesive having the second refraction index, or both.

Based on at least the second material 650, the second waveguide 638 has an associated thickness 654 and weight so as to allow the second waveguide 638 to have the second refractive index and propagate at least a portion of display light 218. In some embodiments, due to, for example, the second material 650 having a lower refractive index than the first material 648, the second waveguide 638 has a lower thickness 654, weight, or both than the thickness 652, weight, or both of the first waveguide 205, respectively. Due to the second waveguide 638 having a lower thickness 654, weight, or both, the thickness, weight, or both of stacked waveguide 640 are also reduced, helping reduce the total weight and size of the HMD that includes the stacked waveguide 640. In this way, the weight and size of the HMD are reduced without any perceptible degradation of the image provided to the eye 222 of the user due to the eye 222 of the user being less sensitive to the portion (e.g., portion 646) of display light 218 provided by the second waveguide 638.

In some embodiments, the first material 648 of the first waveguide 205 is associated with a first parallelism requirement. Such a parallelism requirement, for example, represents a degree of tolerance for the parallelism between the major surfaces (e.g., major surfaces 201, 203) of a waveguide 205, 638. That is to say, a parallelism requirement represents a predetermined degree to which the major surfaces of a waveguide 205, 638 may vary from being parallel. Further, according to embodiments, the second material 650 of the second waveguide 638 is associated with a second parallelism requirement that represents a higher degree of tolerance than the first parallelism requirement of the first material 648. That is to say, the second parallelism requirement represents a higher degree to which the major surfaces of a waveguide 205, 638 may vary from being parallel than the first parallelism requirement. In this way, a less expensive material for the second material 650 of the second waveguide 638 is able to be used to meet the lower demands of the second parallelism requirement which allows a higher degree to which the major surfaces of the second waveguide 638 may vary from being parallel. As such, the cost of the second waveguide 638 is able to be reduced without any perceptible degradation of the image provided to the eye 222 of the user due to the eye 222 of the user being less sensitive to the portion (e.g., portion 646) of display light 218 provided by the second waveguide 638. Further, in some embodiments, the first waveguide 205 includes a linear waveguide (e.g., a waveguide having two linear opposing major surfaces), and the second waveguide 638 includes a non-linear waveguide (e.g., curved waveguide) that includes two non-linear opposing major surfaces.

According to some embodiments, the incoupler 214 of the first waveguide 205 and the incoupler 634 of the second waveguide 638 are misaligned in a lateral direction relative to one another. That is to say, on an axis parallel to a major surface (e.g., major surface 201, 203) of the first waveguide 205, the second waveguide 638, or both, the incoupler 214 is disposed at a first position and the incoupler 634 is disposed at a second position different from the first position such that the incoupler 214 of the first waveguide 205 and the incoupler 634 of the second waveguide 638 are misaligned in a lateral direction relative to one another. Further, for example, when the incoupler 214 of the first waveguide 205 and the incoupler 634 of the second waveguide 638 are misaligned in a lateral direction relative to one another, optical engine 202 is configured to provide a first portion of display light 218 having a first wavelength associated with a first color (e.g., red) and a second portion of display light 218 having a second wavelength associated with a second color (e.g., green) to the incoupler 214. Further, optical engine 202 is configured to provide a third portion of display light 218 having a third wavelength associated with a third color (e.g., blue) to the incoupler 634. As an example, optical engine 202 is disposed so as to provide a first portion of display light 218 having a first wavelength associated with a first color (e.g., red) and a second portion of display light 218 having a second wavelength associated with a second color (e.g., green) to the incoupler 214 and a third portion of display light 218 having a third wavelength associated with a third color (e.g., blue) to the incoupler 634. In embodiments, optical engine 202 is configured to provide the third portion of display light 218 associated with the third color at a lower pixel density than the first and second portions of display light 218 each associated with the first and second wavelengths, respectively. As another example, optical engine 202 includes one or more scan mirrors (e.g., scan mirrors 206, 208) configured to provide a first portion of display light 218 having a first wavelength associated with a first color (e.g., red) and a second portion of display light 218 having a second wavelength associated with a second color (e.g., green) to the incoupler 214 and a third portion of display light 218 having a third wavelength associated with a third color (e.g., blue) to the incoupler 634. According to embodiments, one or more scan mirrors are configured to bin the third portion of display light 218 associated with the third color such that the rendering resolution of the third portion of display light 218 is lower than the rendering resolution of the first and second portions of display light 218 each associated with the first and second wavelengths, respectively.

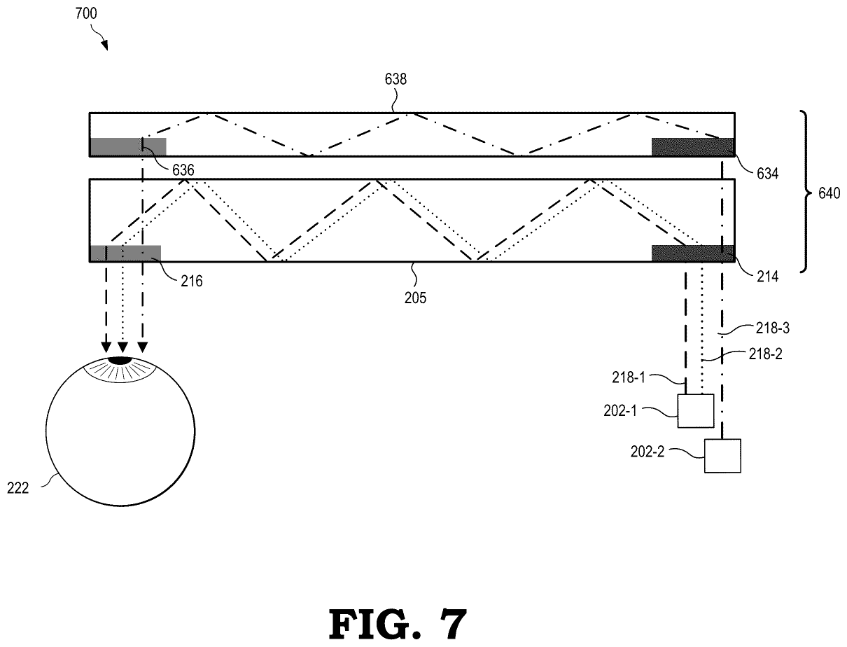

Referring now to FIG. 7, an example configuration 700 for a stacked waveguide configured to receive display light from two or more optical engines is presented. According to embodiments, example configuration 700 is implemented in, for example, display system 100 and is configured to provide an image to an eye 222 of a user an HWD. For example, configuration 700 includes stacked waveguide 640 configured to receive display light 218 from a first optical engine 202-1 and a second optical engine 202-2 and provide the display light 218 to the eye 222 of a user. To this end, the first optical engine 202-1 includes one or more light sources (e.g., laser diodes, LEDs, OLEDs) configured to emit a first display light 218-1 (e.g., a first beam of display light) and a second display light 218-2 (e.g., a second beam of display light) toward the incoupler 214 of the first waveguide 205 of the stacked waveguide 640. The first display light 218-1, for example, includes a first wavelength associated with a first color (e.g., red) and the second display light 218-2 includes a second wavelength associated with a second color (e.g., green) different from the first color. In response to receiving the first display light 218-1 and the second display light 218-2, the incoupler 214 directs the first display light 218-1 and the second display light 218-2 into the first waveguide 205. The first waveguide 205 then provides the first display light 218-1 and the second display light 218-2 to the outcoupler 216 which is configured to direct the first display light 218-1 and the second display light 218-2 out of the first waveguide 205 and toward the eye 222 of the user.

The second optical engine 202-2, for example, includes one or more light sources (e.g., laser diodes, LEDs, OLEDs) configured to emit a third display light 218-3 (e.g., a third beam of display light) toward incoupler 634 of the second waveguide 638 of stacked waveguide 640. The third display light 218-3, as an example, includes a wavelength associated with a third color (e.g., blue) that is different from the first and second colors associated with the first display light 218-1 and the second display light 218-2, respectively. After receiving the third display light 218-3, the incoupler 634 directs the third display light 218-3 into the second waveguide 638. The second waveguide 638 then provides the third display light 218-3 to the outcoupler 636 which directs the third display light 218-3 out of the second waveguide 638 and toward the eye 222 of the user. According to embodiments, the third display light 218-3 is associated with a lower resolution than the first display light 218-1 and the second display light 218-2. That is to say, the second optical engine 202-2 is configured to project an image (e.g., display light representative of an image) at a lower resolution than the resolution at which the first optical engine 202-1 is configured to project an image (e.g., display light representative of the image). To this end, in embodiments, the first optical engine 202-1 is configured to project display light at a first resolution and the second optical engine 202-2 is configured to project display light at a second resolution that is lower than the first resolution. In this way, the cost, size, or both of the second optical engine 202-2 are able to be reduced when compared to the first optical engine 202-1, helping decrease the size and cost of an HMD implementing the optical engines 202. Further, because the eye 222 of the user is less sensitive to blue light than red and green light, reducing the resolution of the second optical engine 202-2 does not perceptively degrade the image provided to the eye 222 of the user and does not negatively impact user experience.

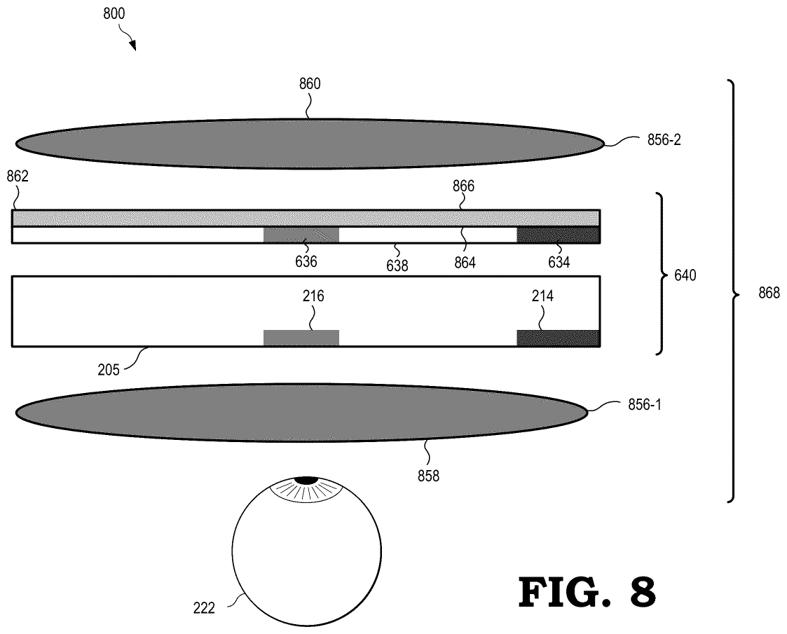

Referring now to FIG. 8, an example configuration 800 for an optical combiner having a stacked waveguide is presented. According to embodiments, example configuration 800 is implemented in one or more HMDs. In embodiments, example configuration 800 includes an optical combiner 868 having a first side (e.g., world-facing side 860) and a second side (e.g., eye-facing side 858). Additionally, optical combiner 868 includes a first lens 856-1 disposed at the world-facing side 860 of the optical combiner 868 and a second lens 856-2 disposed at the eye-facing side 858 of the optical combiner 868. The first lens 856-1 and the second lens 856-2, for example, are the same as or similar to lens elements 108, 110. According to embodiments, example configuration 800 includes stacked waveguide 640 disposed between the first lens 856-1 and the second lens 856-2. To this end, the first waveguide 205 of the stacked waveguide 640 is disposed near the first lens 856-1 (e.g., near the eye-facing side 858 of the optical combiner 868). The first waveguide, for example, includes incoupler 214 and outcoupler 216 configured to provide at least a portion of display light 218 (e.g., red light, green light) to the eye 222 of the user. Further, the second waveguide 638 of the stacked waveguide 640 is disposed near the second lens 856-2 (e.g., near the world-facing side 860 of the optical combiner 868). The second waveguide 638 includes incoupler 634 and outcoupler 636 configured to provide at least a second portion of display light 218 (e.g., blue light) to the eye 222 of the user.

According to embodiments, the optical combiner 868 further includes a substrate 862 that includes first and second opposing surfaces (e.g., first surface 864 and second surface 866) and is disposed between the first lens 856-1 and the second lens 856-2. In some embodiments, for example, the substrate 862 is configured to protect the first lens 856-1, second lens 856-2, the first waveguide 205, the second waveguide 638, or any combination thereof from damage (e.g., scratches) due to external material (e.g., dust, dirt, sand), external forces (e.g., from users, from cleaning) or both. The substrate 862, for example, is formed from a plastic material, glass material, or both having a refractive index equal to the second waveguide 638. In embodiments, the second waveguide 638 is disposed on a surface 864, 866 of the substrate 862. For example, the second waveguide 638 is bonded to a surface 864, 866 of the substrate 862 using, for example, a vacuum, an adhesive having a refractive index equal to the second waveguide 638 and the substrate 862, or both. As another example, the second waveguide 638 is directly imprinted on a surface 864, 866 of the substrate 862. As yet another example, the second waveguide 638 is laminated on a surface 864, 866 of the substrate 862.

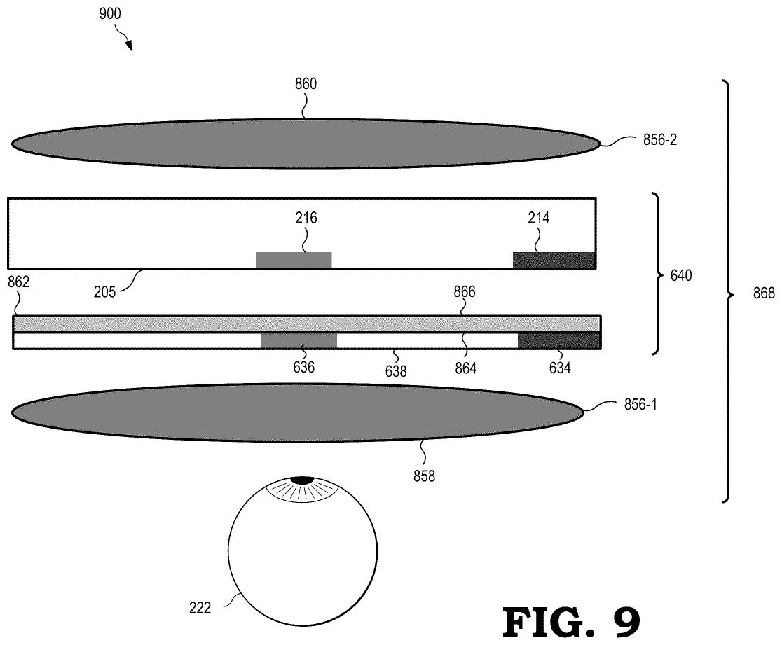

Referring now to FIG. 9, another example configuration 900 for an optical combiner having a stacked waveguide is presented. According to embodiments, example configuration 900 is implemented in one or more HMDs. In embodiments, example configuration 900 includes the optical combiner 868 having stacked waveguide 640 disposed between the first lens 856-1 and the second lens 856-2 of the optical combiner 868. To this end, within the example configuration 900, the first waveguide 205 of the stacked waveguide 640 is disposed near the second lens 856-2 (e.g., near the world-facing side 860 of the optical combiner 868). Further, the second waveguide 638 of the stacked waveguide 640 is disposed near the first lens 856-1 (e.g., near the eye-facing side 858 of the optical combiner 868). According to embodiments, in example configuration 900, optical combiner 868 further includes substrate 862 disposed between the first lens 856-1 and the second lens 856-2. In some embodiments, the second waveguide 638 is disposed on a surface 864, 866 of the substrate 862.

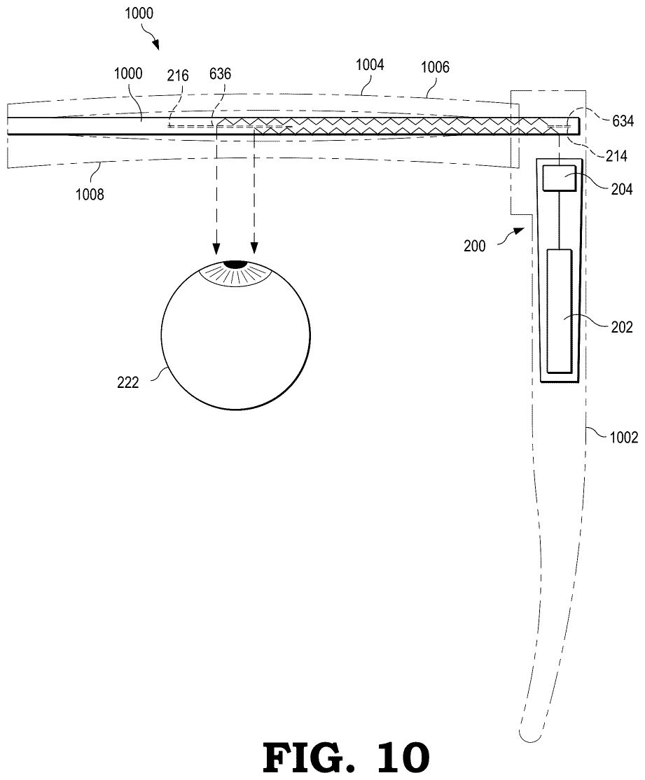

FIG. 10 illustrates a portion of an HMD 1000 that includes a stacked waveguide. For example, according to embodiments, HMD 1000 includes stacked waveguide 640. In some embodiments, the HMD 1000 represents the display system 100 of FIG. 1. The optical engine 202, optical scanner 204, and a portion of the stacked waveguide 640 with incouplers 214, 634 are included in an arm 1002 of the HMD 1000, in the present example.

The HMD 1000 includes an optical combiner lens 1004, similar to or the same as optical combiner 868, which includes a first lens 1006, a second lens 1008, and the stacked waveguide 640, with the stacked waveguide 640 disposed between the first lens 1006 and the second lens 1008. Display light 218 exiting through the outcouplers 216, 636 travels through the second lens 1008 (which corresponds to, for example, the lens element 110 of the display system 100). In use, the light exiting second lens 1008 enters the pupil of an eye 222 of a user wearing the HMD 1000, causing the user to perceive a displayed image carried by the display light 218 output by one or more optical engines 202.

According to embodiments, the optical combiner lens 1004 is substantially transparent, such that light from real-world scenes corresponding to the environment around the HMD 1000 passes through the first lens 1006, the second lens 1008, and the stacked waveguide 640 to the eye 222 of the user. In this way, images or other graphical content output by the projection system 200 are combined (e.g., overlayed) with real-world images of the user's environment when projected onto the eye 222 of the user to provide an AR experience to the user.

Although not shown in the depicted example, in some embodiments additional optical elements are included in any of the optical paths between the optical engines 202 and the incouplers 214, 634, in between the incouplers 214, 634 and the outcouplers 216, 636 and/or in between the outcouplers 216, 636 and the eye 222 of the user (e.g., in order to shape the display light for viewing by the eye 222 of the user). As an example, a prism is used to steer light from the optical scanner 204 into the incouplers 214, 634 so that light is coupled into incouplers 214, 634 at the appropriate angle to encourage propagation of the light in stacked waveguide 640 (e.g., the first waveguide 205 and the second waveguide 638) by TIR. Also, in some embodiments, one or more exit pupil expanders (e.g., the EPE 324) including, for example, fanout gratings 330 are arranged in an intermediate stage between incouplers 214, 634 and outcouplers 216, 636, respectively, to receive light that is coupled into stacked waveguide 640 by the incouplers 214, 634, expand the light, and redirect the light towards the outcouplers 216, 636, respectively where the outcouplers 216, 636 then couple the display light out of the stacked waveguide 640 (e.g., toward the eye 222 of the user).

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A stacked waveguide, comprising:
a first waveguide including a first incoupler configured to direct a first portion of a display light having a first wavelength and a second portion of the display light having a second wavelength into the first waveguide, wherein the first wavelength is different from the second wavelength; and
a second waveguide including a second incoupler configured to direct a third portion of the display light having a third wavelength into the second waveguide, wherein the third wavelength is different from the first wavelength and the second wavelength.

2. The stacked waveguide of claim 1, wherein the first waveguide includes a first material and the second waveguide includes a second material that is different from the first material.

3. The stacked waveguide of claim 2, wherein the second material includes a plastic film.

4. The stacked waveguide of claim 1, wherein the first waveguide is associated with a first parallelism requirement and the second waveguide is associated with a second parallelism requirement that is lower than the first parallelism requirement.

5. The stacked waveguide of claim 1, wherein the second waveguide is disposed on a surface of a plastic substrate.

6. The stacked waveguide of claim 1, wherein the third wavelength is associated with blue light.

7. The stacked waveguide of claim 1, wherein the first waveguide has a first refractive index and the second waveguide has a second refractive index that is less than the first refractive index.

8. A method, comprising:
emitting display light toward a first incoupler of a first waveguide and a second incoupler of a second waveguide;
directing, by the first incoupler, a first portion of the display light having a first wavelength and a second portion of the display light having a second wavelength into the first waveguide, wherein the first wavelength is different from the second wavelength; and
directing, by the second incoupler, a third portion of the display light having a third wavelength into the second waveguide, wherein the third wavelength is different from the first wavelength and the second wavelength.

9. The method of claim 8, wherein the first waveguide includes a first material and the second waveguide includes a second material that is different from the first material.

10. The method of claim 9, wherein the second material includes a plastic film.

11. The method of claim 10, wherein the first material comprises glass.

12. The method of claim 8, wherein the first waveguide comprises a linear waveguide and the second waveguide comprises a non-linear waveguide.

13. The method of claim 8, wherein the third wavelength is associated with blue light.

14. The method of claim 8, wherein the first waveguide has a first refractive index and the second waveguide has a second refractive index that is less than the first refractive index.

15. A head-worn display (HWD), comprising:
one or more optical engines configured to emit display light;
a first waveguide including a first incoupler configured to direct a first portion of the display light having a first wavelength and a second portion of the display light having a second wavelength into the first waveguide, wherein the first wavelength is different from the second wavelength; and
a second waveguide including a second incoupler configured to direct a third portion of the display light having a third wavelength into the second waveguide, wherein the third wavelength is different from the first wavelength and the second wavelength.

16. The HWD of claim 15, wherein the one or more optical engines include:
a first optical engine configured to emit the first portion of the display light and the second portion of the display light; and
a second optical engine configured to emit the third portion of the display light, wherein the second optical engine has a lower resolution than the first optical engine.

17. The HWD of claim 15, wherein the first waveguide includes a first material and the second waveguide includes a second material that is different from the first material.

18. The HWD of claim 15, wherein the first waveguide includes a first outcoupler configured to direct the first portion of the display light and the second portion of the display light toward an eye of a user and wherein the second waveguide includes a second outcoupler configured to direct the third portion of the display light toward the eye of a user.

19. The HWD of claim 15, wherein the second waveguide is disposed on a surface of a plastic substrate.

20. The HWD of claim 15, wherein the first waveguide has a first refractive index and the second waveguide has a second refractive index that is less than the first refractive index.
